(19) United States
(12) Patent Application Publication
(10) Pub. No.: US 2023/0222616 A1
(43) Pub. Date: Jul. 13, 2023

(54) WAGERING ACCOUNTING AND REPORTING

(71) Applicant: CFPH, LLC, New York, NY (US)

(72) Inventor: Phillip Flaherty, Las Vegas, NV (US)

(21) Appl. No.: 18/188,663

(22) Filed: Mar. 23, 2023

Related U.S. Application Data
(63) Continuation of application No. 13/796,810, filed on Mar. 12, 2013, now abandoned.

(51) Int. Cl. G06Q 40/12; G06Q 50/34

(52) U.S. Cl. CPC G06Q 40/123; G06Q 50/34

(57) ABSTRACT

A computer gaming system receives a specification of rules for revenue recognition, reporting, or allocation of proceeds of gaming activities among entities having claims to proceeds in conjunction with bettors of the gaming activity. The specification may describe and reflect changes in inter-jurisdiction tax treaties or compacts, or agreements among commercial operators. During or at conclusion of gaming activities by players through the gaming system, amounts of revenue, tax payable, or tax withholding, relating to the gaming activities are computed from the specification, for a plurality of horizontally-related tax jurisdictions, players and operators of the gaming activity having taxable contacts with the horizontally-related tax jurisdictions. The computation may reflect a tax compact or treaty among the horizontally-related jurisdictions to specify interjurisdictional treatment of the revenue, tax payable, or withholding. Proceeds of the gaming activities of the players are reported and/or allocated to operators and/or jurisdictions as specified by the computation.

### CROSS REFERENCE TO RELATED APPLICATIONS

This application is a continuation of U.S. patent application Ser. No. 13/796,810 filed Mar. 12, 2013, which is incorporated by reference herein in its entirety.

### BACKGROUND

This application relates to reporting and reconciling taxable events and liabilities, to preparing a tax or information return or other tax filing, and to a computer system that records, transmits, transfers, or organizes data related to such filing.

### SUMMARY

In general, in a first aspect, the invention features a method. A specification of rules for revenue recognition, reporting, or allocation of proceeds of gaming activities among a plurality of entities having claims to proceeds in conjunction with bettors of the gaming activity is received into a memory of a computer gaming system. The computer system is programmed to accept the specification in a form that can be specified and/or amended by a human being to describe and reflect changes in inter-jurisdiction tax treaties or compacts, or agreements among commercial operators. During or at conclusion of gaming activities by players through the gaming system, the computer system computes reporting and/or allocation of proceeds of the gaming activities of the players to operators and/or jurisdictions as specified by the specification.

In general, in a second aspect, the invention features a method. For a plurality of horizontally-related tax jurisdictions, a computer system computes respective taxable amounts of revenue, tax payable, or tax withholding, relating to gaming activities conducted in the computer gaming system. Players and operators of the gaming activity have taxable contacts with a plurality of horizontally-related tax jurisdictions. The computation reflects a tax compact or treaty among the horizontally-related jurisdictions to specify interjurisdictional treatment of revenue, tax payable, or withholding. During or at conclusion of gaming activities by players through the gaming system, the computer system reports and/or allocates proceeds of the gaming activities of the players to the horizontally-related jurisdictions as specified by the computation. Embodiments of the invention may include one or more of the following features. The tax jurisdictions may be horizontally related, vertically related, or unrelated. The proceeds may be taxable in at least one of the jurisdictions and nontaxable in at least one of the jurisdictions. The proceeds may be taxable at two different tax rates in at least two respective ones of the jurisdictions. The allocation may relate to allocation of proceeds, commission, rake, or entry fees among operators of the gaming activity. The horizontally-related jurisdictions may be drawn from at least two of the following categories: (a) states of United States; (b) a city within a state having a city gaming or income tax separate from state gaming or income tax; (c) an Indian tribe; and/or (d) a foreign country other than the United States, and/or a tax jurisdiction within such a country having a gaming or income tax above the country's tax.

The above advantages and features are of representative embodiments only and are presented only to assist in understanding the invention. They are not to be considered limitations on the invention as defined by the claims. Additional features and advantages of embodiments of the invention will become apparent in the following description, from the drawings, and from the claims.

### DESCRIPTION OF THE DRAWINGS

FIG. 1 is a block diagram of a computer system.

FIG. 2 is a pseudo-code description of a computation.

### DESCRIPTION

The Description is organized as follows.
I. Overview
II. W2G Generation and other reporting
III. Implementation

### I. Overview

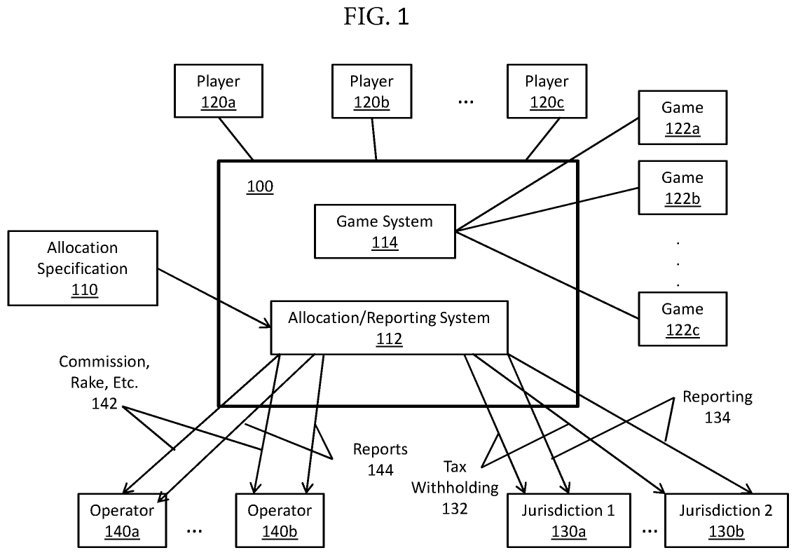

Referring to FIG. 1, interactive gaming system 100 is programmed to accept specification 110 that specifies allocation, reporting, or reconciliation of (a) tax liabilities 132 of players 120 among multiple jurisdictions 130 that have claims to taxes on the proceeds of gaming activity in the gaming system, and/or (b) tax reporting for individual players 120 who utilize the system and enjoy either a qualifying reportable and/or taxable and/or withholding event(s) either within a jurisdiction or across multiple jurisdictions, and/or (c) commissions, profits, losses, liabilities, or rake 142 of interactive gaming activity among multiple commercial operators 140 that participate in gaming system 100. Computer system 100 may accept specification 110 that can be specified and/or amended by a human being to describe and reflect changes in inter-jurisdiction tax treaties or compacts, or agreements among commercial operators 140. As players participate in gaming activities 122, computer system 100 may evaluate a specific monetary event against specification 110 to allocate funds 132, 142 and generate reporting documents 134, 144 as appropriate.

Several states have laws that permit and/or regulate gaming by out-of-state players. In some cases, the player's state and the gaming operator's state may have a treaty or compact that specifies taxation of the player's gaming winnings, and division of tax revenue among the states. In addition, gaming winnings may trigger W2G, 1099, 1042 S, or similar tax reporting to the federal government. In addition, some gaming activity may be co-hosted through multiple operators 140 that have revenue-sharing agreements among themselves. Allocation/reporting system 112 may collect data at each taxable event (for example, a win of a bet, especially a win that takes the player's winnings for a day above a threshold for W2G, 1099, or 1042 S reporting), may withhold part of the winnings if player 120 is subject to withholding, and/or may generate an appropriate reporting document to the relevant taxing authority 130.

Gaming activity 122 hosted on or communicated through gaming system 114 may include any activity that places money at risk based on a difference of opinion and/or outcome of an event, including betting on or entry fees and payouts for games of chance, casino games, horse or dog racing, sports betting, slot machine betting, bingo, card games, roulette, lotto, etc., games of skill, chess, checkers, fantasy sports, games with mixed skill and chance, including board games, poker, card games, Scrabble, Risk, MMORPG's (massively multiplayer online role-playing games), tournaments, or others. Gaming may include risk propositions on games played by players 120 themselves, where the bettors and game participants are one and the same and players 120 bet on themselves (for example, a bet between poker, checkers, or Risk players), games against the house (roulette, craps, etc.), or games where gamers bet on an external event, where the bettor 120 and the bet-upon participants are different entities (a horse race, a fantasy sports game, etc.).

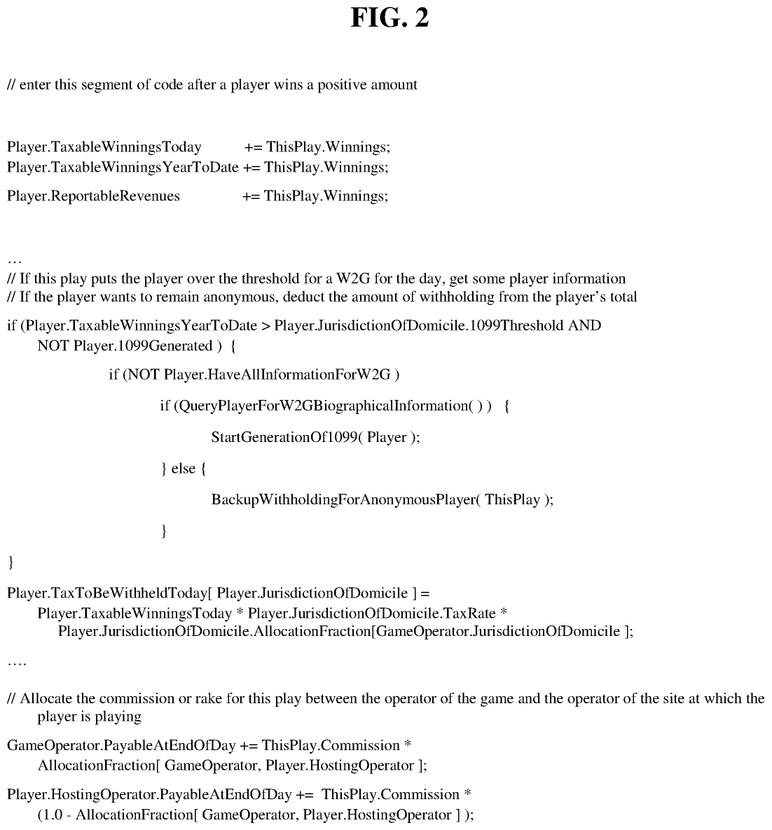

Referring to FIG. 2, allocation/reporting system 112 may accept allocation specification 110 written in an existing high-level, scripting, application-within-an-application, or procedural language (such as Visual Basic and its variants, Java, JavaScript, Perl, Python, Ch, SQL, etc.) or in a spreadsheet language such as Microsoft Excel.

In some cases, allocation/reporting system 112 may accept allocation specification 110 written in a special-purpose language specially designed for coding of allocation specifications. A special-purpose language may be a procedural, declarative, or table-oriented language. In some cases, specification 110 may be stored in the form of a hierarchical or relational database. In some cases, a compiler or translator in computer system 112 may translate human-readable allocation specification 110 into a form that is more rapidly executable, such as processor-specific object code, Java byte-codes, P-code, or some other executable form. In some cases, specification 110 may be interpreted by an interpreter without translation.

Arrangements for withholding, reporting, and allocation of taxes among various operators or jurisdictions may be hard-coded into software. The entire system may be hard coded, or the system may provide hard-coded components that are parameterized and selected by a user-modifiable specification 110, or various components and techniques may be combined.

Allocation/reporting system 112 and allocation specification 110 may process and refer to one or more of the following attributes of the player:
jurisdiction of domicile, particularly for tax purposes
jurisdiction of citizenship
jurisdiction in which the player is physically located while playing the game
jurisdiction where the counterparty player(s) is/are located

The specification may be sufficiently detailed that it can allocate tax liabilities or commission income in cases where players 120 of a single game 122 are participating from several jurisdictions. For example, in a poker tournament, players and/or operators may have tax obligations to a number of different tax jurisdictions. Specification 110 may provide for allocation as provided by treaties or compacts among those jurisdictions.

Allocation/reporting system 112 and allocation specification 110 may process and refer to one or more of the following attributes of an operator of game 122:
jurisdiction of domicile of the corporate entity, either the domicile of corporate form or the principal place of business
jurisdiction in which the particular operator is licensed
jurisdiction(s) in which operators extend service (an operator may be licensed in one jurisdiction and may be permitted to offer service in alternative jurisdictions via inter-jurisdiction treaty or compact)
jurisdiction of location of server 114 that hosts gaming activities
jurisdiction of bank accounts from/to which the operator's funds flow
form of the entity: a private party and its corporate form, a state of the United States acting as a market participant, an Indian tribe acting under a pre-Constitution treaty, an Indian tribe under a post-Constitution treaty, etc.
role of the operator in the game—the licensee of the game, the operator of the betting parlor where players 120 is doing the betting, an intellectual property holder that is due a royalty for play operated by the licensee, etc. In some situations, multiple operators may have cooperative agreements for splitting of profits.

Allocation/reporting system 112 and allocation specification 110 may process and refer to one or more of the following attributes of the jurisdictions involved:

whether the jurisdiction is a state acting as tax sovereign, an Indian tribe, whether that tribe's treaty with the United States was entered before or after the adoption of the Constitution in 1789
whether the jurisdiction is a unitary tax jurisdiction or not
the jurisdiction's applicable gaming and income tax rates

Depending on the complexity of the game, the parties involved, and of the interstate tax treaty, the situations may become rather complex, and the programming may reflect that complexity. For example, in a game of online poker, players may be participating from New Jersey and California, and from the territory of an Indian tribe in Connecticut, and the operator may be licensed in Nevada. Each player may contribute to the pot in different proportions and may take winnings in different proportions. If one player wins, the winnings may be taxed under the Nevada situs of the operator, while if another player wins, the winnings may be taxed under the law of the location of the winner. The tax payable by the operator may vary depending on which player wins the pot.

Tax jurisdictions may be vertically related so that each has a separate claim (for example, the relationship of the United States federal government with a state), or may be horizontally related (for example, as between two states that desire to ensure that a taxable event is allocated between them to avoid unfair double taxation). Computer system 112 may be programmed to ensure that taxes are accurately reported and reconciled among all applicable jurisdictions, or some subset of all involved jurisdictions. Computer system 112 may be programmed to assure that all required events and/or transactions have been captured and that all revenue and/or taxable amounts are reported, and that the disposition of funds balances to gross total revenues.

Some tax jurisdictions may have different tax rates for locations included within. For example, New Jersey may charge different tax rates depending on whether player 120 or game 122 or gaming system 114 is in Atlantic City or in Trenton.

Likewise, if players 120 and games 122 are provided by or hosted by multiple different operators 140, computer system 112 may compute splits and allocations of revenue, profits, commissions, etc. among them. For example, players that are members of one web site may be referred by their home web sites to a game 122 hosted by another operator, and the operator of game 122 may pay a referral fee or commission to the player's home web site. Or an operator of a sports book may contract out the book through casinos or hotels, and the casino or hotel may be due a share of the profits from players referred to the sports book operator. Typically, the revenue or profit split among operators will be specified by contracts between operators. Alternatively, one operator may issue a general invitation to web site owners with a fixed rate deal to pay a commission for referrals, and the commission may be specified based on criteria similar to those listed above for tax allocation. The rules for revenue sharing may be included in allocation specification 110 or may be hard-coded into allocation/reporting system 112.

Web sites for gaming may adopt some form of affiliate marketing program, in which an introducing affiliate that brings a player 120 in to gaming host 114 may receive a commission for some portion of the business that player 120 conducts on gaming host 114. This division of commission may be specified by contract between the operator of gaming host 114 and the introducing affiliate, or it may be specified by law. In some cases, the claim to commission by the introducing affiliate may extend into the future for gaming by player 120, even future gaming activity in which player 120 comes into gaming host 114 by some path that does not directly involve the introducing affiliate.

Some jurisdictions may require marketing affiliates to be licensed, some may not. In cases where marketing affiliates must be licensed, the license may specify conditions on which commissions or referral fees may be paid or shared. In cases where one of the entities operating the game (typically the jurisdiction governing gaming system 114), that jurisdiction may limit or regulate commission sharing among marketing affiliates differently depending on attributes of the marketing affiliate. For example, the commission rate payable to the marketing affiliate may be lower—or zero—if the marketing affiliate is not licensed by the jurisdiction covering gaming host 114. The two jurisdictions (the one covering gaming system 114 and the one covering the marketing affiliate) may each require some corporate contact, so that each jurisdiction has a regulatory “hostage” in order to control gaming activities that occur in a foreign jurisdiction but that may have effect in the jurisdiction exercising regulatory authority.

Computer system 112 may generate appropriate revenue reporting for commercial purposes among the various operators, for regulatory reporting, and for tax reporting. The complexity of the reporting may be complicated by various jurisdictions' rules on commissions, license requirements, reporting of affiliate commissions, reporting for tax obligations, contractual terms among the affiliates themselves, and other enterprises. All of these factors may be expressed in allocation specification 110.

### II. W2G Generation and Other Reporting

Players and/or game operators 140 may be legally required to report winnings from gaming on income tax returns. Players may be required to report such winnings on income tax returns filed with federal, state, and/or local governments.

In account-based wagering systems, player 120 may provide information relating to identity, social security number or other taxpayer ID, nationality and residence (and any other personal information that may affect taxation), and bank account information at the time that the account is set up and funded. This same information may be used to generate W2G, 1099, and 1042 S reporting in the event that winnings exceed losses.

Players 120 may choose to engage in gaming activities anonymously. Players may have an incentive not to report winnings to government authorities so as to avoid having to pay taxes on the winnings. Players may reason that since no one knows who they are, no one will be able to prove that they have won money.

In some cases, computer system 100 may request and store additional information about player 120 that may affect tax liability, in the manner of an employment W4. For example, tax liability may be influenced by domicile, citizenship, marital status, overall income, number of children, home ownership, and other factors. Computer system 100 may request information, either as a part of the registration function or at the time of a taxable or reportable event, from or about player 120 that may affect tax liability. Computer system 100 may validate the information, for example, by querying against public databases. Player 120 may authorize computer system 100 to query his/her own tax records to validate the tax liability information.

Players 120 may interact with computer system 100 via an in-casino or trackside kiosk, a video poker machine or slot machine, handheld or other mobile gaming devices, terminals in a casino or airport, or other electronic device.

Computer system 100 may be programmed to recognize revenue. In accrual based accounting, revenue is recognized when (a) a firm has performed all, or substantially all, or a substantial portion, of the services it expects to provide, and (b) the firm has received cash, a receivable, or some other asset susceptible to reasonably precise measurement.

When a player 120 wins an amount above some threshold amount (currently $5000 for poker, and other amounts as defined for certain types of activities), the casino or other house may be under a legal obligation to collect identifying information before or concurrently with paying out the winnings to player 120. When such a threshold event occurs, or at player registration, or at some other time, the casino or other gaming operator may require player 120 to provide the casino with identifying information required by tax authorities, for example, name, social security number or other taxpayer ID, and citizenship, and may require player 120 to sign or electronically sign or electronically confirm in some manner, a W2G, W-8s, W-8BEN, W-8ECI, W-8IMY, 8233, 1099, 1042 S or other such other document as required by the applicable affected jurisdiction, in order to receive the full amount of the winnings. The casino may be obligated to report the player's identity, taxpayer ID, and the amount of the winnings to one or more government tax authorities. The amount of tax due may vary with the residence or nationality of player 120. If player chooses to remain anonymous, the casino may be required to simply withhold tax at the highest applicable rate.

Computer system 112 may be programmed to perform reporting functions, including generating Forms 1099, W2G, etc. in which a payor reports any taxable event to a tax jurisdiction. Computer system 112 may also generate reports required by the applicable jurisdiction(s) regarding information needed for regulatory or tax purposes.

Allocation/reporting system 112 may be given information to set legal or other standards or thresholds for tax reporting. This information may be updated any time tax laws change.

As players 120 game, computer system 112 may provide players 120 with the ability to query their tax status, and their current winnings/losses and tax liability. To the degree that computer system 112 has the information available, it may provide player 120 with information describing the current day's gaming, year-to-date, or other relevant time period, and may provide information relating to gaming winnings and losses for specific jurisdictions, such as winnings, losses, and taxes due to a given country, state, city, or other geographical region or tax jurisdiction. To the degree computer system 112 has access to the information, computer system 112 may report information relating to winnings and losses in other casinos and may separate taxable from tax-free gaming (for example, gaming on behalf of charitable organizations or tax-exempt entities like certain Indian tribes). Computer system 112 may provide information on taxes due to different governmental entities.

Computer system 112 may show to player 120 any losses that may be used to offset future winnings. Computer system 110 may track player win/loss per individual, per jurisdiction, per tax reporting tax period. While tax laws do not require game operators 122 to track and report player losses to tax authorities, individual players 120 may request loss information at the time of filing personal tax returns, in order to offset winnings and reduce tax liability. In cases where allocation/reporting system 112 tracks information at the level of individual/jurisdiction/period, allocation/reporting system 112 can make that information available to patrons. Gaming operators can build customer loyalty by providing gross and net information to customers for personal tax reporting at state, federal and other jurisdictional tax reporting levels.

In some cases where the casino or other betting house withholds part of a player's winnings, the money may be held in escrow in case the money needs to be paid in taxes. However, if a winning betting day or year later turns out to be a loser, the casino or house may return money from the escrow to the player. Such escrowing may be easier in cases where player 120 maintains an open account with the casino. At the end of the tax year or other tax period, or at the time that player 120 closes the account, money in a player's escrow account may be automatically provided to the Internal Revenue Service or to some other governmental authority. Any money remaining in the escrow account may be returned to the player.

In addition to providing reporting information to governmental tax authorities and to revenue-share operators, allocation/reporting system 112 may send an electronic report of the player's win/loss information to the player, to be plugged into TurboTax or similar tax preparation software.

U.S. Pat. No. 8,210,931 is incorporated by reference.

### III. Implementation

Various processes described herein may be implemented by appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, or one or more scripts. The processing may be performed on one or more microprocessors, central processing units (CPUs), computing devices, microcontrollers, digital signal processors, or like devices or any combination thereof. Programs that implement the processing, and the data operated on, may be stored, and transmitted using a variety of media. In some cases, hard-wired circuitry or custom hardware may be used in place of, or in combination with, some or all of the software instructions that can implement the processes. Algorithms other than those described may be used.

In some cases, the processor or program that computes and allocates tax computation may be the same as, or integrated with, the processor or program suite that manages the gaming activity itself. In some cases, they may be under common ownership or management. In some cases, they may be in the same multiprocessor chassis, or on the same local area network, where player gaming commands come over a wide-area network. In some cases, they may be on separate nodes of a wide-area network.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, electromagnetic domains or spots, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

Processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

A list of items does not imply that any or all of the items are mutually exclusive, nor that any or all of the items are comprehensive of any category, unless expressly specified otherwise.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. In many cases, one feature or group of features may be used separately from the entire apparatus or methods described. Many of those undescribed variations, modifications and variations are within the literal scope of the following claims, and others are equivalent.

1. A method, comprising the steps of:
receiving into a memory of a computer gaming system, a specification of rules for revenue recognition, reporting, or allocation of proceeds of gaming activities among a plurality of entities,
the entities having claims to proceeds in conjunction with bettors of the gaming activity,
the computer system being programmed to accept the specification in a form that can be specified and/or amended by a human being,
the specification in a form that can be specified and/or amended to describe and reflect changes in inter-jurisdiction tax treaties or compacts, or agreements among commercial operators,
players and operators of the gaming activity having taxable contacts with a plurality of tax jurisdictions,
the tax jurisdictions being horizontally-related to each other;
in the memory of a computer gaming system, during or at conclusion of gaming activities by players through the gaming system, from the specification, computing taxable amounts of revenue, tax payable, or tax withholding,
the amounts being reportable or due to a plurality of different and horizontally-related tax jurisdictions,
the respective taxable amounts of revenue, tax payable, or tax withholding, relating to the gaming activities,
the computation reflecting a tax compact or treaty among the horizontally-related jurisdictions to specify interjurisdictional treatment of the revenue, tax payable, or withholding; and
reporting and/or allocating proceeds of the gaming activities of the players to operators and/or jurisdictions as specified by the computation.
